(19) United States
(12) Patent Application Publication
(10) Pub. No.: US 2012/0331564 A1
(43) Pub. Date: Dec. 27, 2012

(54) INFORMATION PROCESSING APPARATUS, SERVER, INFORMATION PROCESSING SYSTEM, INFORMATION PROCESSING METHOD, AND PROGRAM

(75) Inventors: Junichiro Enoki, Tokyo (JP); Kohei Miyamoto, Kanagawa (JP); Keisuke Chida, Tokyo (JP); Ryohei Okada, Chiba (JP); Takeshi Kunihiro, Kanagawa (JP)

(73) Assignee: SONY CORPORATION, Tokyo (JP)

(21) Appl. No.: 13/517,781

(22) Filed: Jun. 14, 2012

(30) Foreign Application Priority Data
Jun. 24, 2011 (JP) 2011-140935

(51) Int. Cl. G06F 21/00

(52) U.S. Cl. 726/27; 726/26

(57) ABSTRACT

There is provided an information processing apparatus, including a behavior information generating unit that generates behavior information, a behavior pattern analyzing unit that analyzes a behavior pattern based on the behavior information, a similarity determining unit that performs a similarity determination of the analyzed behavior pattern and a protection target behavior history pattern, a protection selecting unit that selects a protection level of the behavior information based on a result of the similarity determination, and a behavior information protecting unit that protects the behavior information based on the selected protection level.

### BACKGROUND

The present technology relates to an information processing apparatus, a server, an information processing system, an information processing method, and a program. Specifically, behavior history information desired to be concealed can be easily and appropriately protected.

In recent years, devices with a function of acquiring position information such as portable information terminal apparatuses have been widely spreading. Further, studies have been conducted, for example, on techniques of estimating a moving status, like whether a user is walking or a user is moving by a means of transportation such as an electric train, using a sound collected by a microphone, a sensor output of an acceleration sensor, or the like.

Further, services that disclose behavior history or share position information using devices with a function of acquiring position information have been introduced.

However, when history of all behaviors is open to the public, there is a risk that position information such as home, a place of work, and a place of study, position information such as a destination which is undesired to be disclosed to other people, or the like will be known by the public. Thus, before behavior history is disclosed to the public, it is necessary to determine each time whether or not personal information is leaked. In order to solve this problem, Japanese Patent Application Laid-Open No. 2009-151379 discloses a technique of protecting position information related to personal information by determining whether or not measured position information corresponds to the inside of a previously set protection area and then controlling the disclosure of information based on the determination result.

### SUMMARY

However, when the protection area is set, if the protection area is narrow, a destination which is within the protection area and undesired to be disclosed to the public may be inferred based on position information disclosed to the public. Further, when the protection area is broad, position information may not be disclosed to the public even when it is not directed toward a destination undesired to be disclosed to the public, and there is a high possibility of overprotection. Further, when the user forgets to set the protection area, it is difficult to protect position information of a destination undesired to be known to the public.

In this regard, the present technology provides an information processing apparatus, an information processing system, a server, an information processing method, and a program, which are capable of easily and appropriately protecting behavior history information desired to be concealed.

According to an embodiment of the present technology, there are provided an information processing apparatus which includes a behavior information generating unit that generates behavior information, a behavior pattern analyzing unit that analyzes a behavior pattern based on the behavior information, a similarity determining unit that performs a similarity determination of the analyzed behavior pattern and a protection target behavior history pattern, a protection selecting unit that selects a protection level of the behavior information based on a result of the similarity determination, and a behavior information protecting unit that protects the behavior information based on the selected protection level, an information processing method, and a program.

In the present technology, behavior information which includes position information or position information and information representing a means of transportation together with time information is generated, and a behavior pattern is analyzed based on the behavior information. It is determined whether or not the analyzed behavior pattern is similar to a protection target behavior history pattern which is a behavior pattern based on behavior history information representing a position or an area designated by a user. For example, it is determined whether or not there is a similarity in a path based on position information or whether or not there are a similarity in a path based on position information and a similarity in a behavior time slot based on time information. Further, when the behavior information includes the information representing a means of transportation, it is determined there is a similarity in a means of transportation. A protection level of the behavior information is selected based on the similarity determination result. When a similarity is high, a high protection level is selected, and protection of the behavior information is performed based on the selected protection level. The protection target behavior history pattern is registered in the protection target behavior history pattern database unit. Further, the registered protection target behavior history pattern is updated when new behavior information is generated or updated using a protection target behavior history pattern supplied from the outside. The protection level of the behavior history information is changeable.

According to another embodiment of the present technology, there are provided a server which includes a behavior history information recording unit that records behavior information, in which a behavior pattern is analyzed from behavior information generated by a terminal apparatus, and a protection level of the behavior information is selected based on a similarity determination of the analyzed behavior pattern and a protection target behavior history pattern, as behavior history information, a determining unit that determines a request source of the behavior history information, an access right database unit that selects an access right corresponding to the determined request source, and an information provision processing unit that provides the requested behavior history information when it is determined that the requested behavior history information has a protection level in which access is permitted by the access right corresponding to the request source based on the access right corresponding to the request source and the protection level of the requested behavior history information, an information processing method, and a program.

In the present technology, when the recorded behavior history information is requested, a request source is determined, and an access right is selected. When the requested behavior history information has the protection level in which access is permitted by the access right corresponding to the request source, behavior history information is provided to the request source, for example, display information representing a behavior history pattern based on the behavior history information is provided to the request source. Further, by performing analysis of a behavior pattern based on behavior information supplied from an information terminal, a similarity determination of the analyzed behavior pattern and a protection target behavior history pattern, selection of a protection level of behavior information based on the similarity determination result, and protection of the behavior information according to the selected protection level by the server, an information terminal having a simple configuration can be also used. Furthermore, by integrating protection target behavior history patterns registered in protection target behavior history pattern database units of information terminals and registering the integrated database in the protection target behavior history pattern database units of the information terminals, the protection target behavior history pattern can be shared, and information can be protected.

According to still another embodiment of the present technology, there is provided a server configuring a part of an information processing system. The server includes a determining unit that determines a request source of behavior history information, an access right database unit that selects an access right corresponding to the determined request source, and an information provision processing unit that provides the requested behavior history information when it is determined that the requested behavior history information has a protection level in which access is permitted by the access right corresponding to the request source based on the access right corresponding to the request source and the protection level of the requested behavior history information. The system includes an information terminal, and at least one of the information terminal and the server further includes a behavior pattern analyzing unit that analyzes a behavior pattern based on the behavior information supplied from the information terminal, a similarity determining unit that performs a similarity determination of the analyzed behavior pattern and a protection target behavior history pattern, a protection selecting unit that selects a protection level of the behavior information based on a result of the similarity determination, and a behavior information protecting unit that protects the behavior history information which is behavior information in which a protection level is selected based on the selected protection level.

According to still another embodiment of the present technology, there is provided an information processing system which includes an information terminal that generates behavior information, and a server that provides behavior history information in response to a request, and an information processing method. At least one of the information terminal and the server includes a behavior pattern analyzing unit that analyzes a behavior pattern based on the behavior information, a similarity determining unit that performs a similarity determination of the analyzed behavior pattern and a protection target behavior history pattern, a protection selecting unit that selects a protection level of the behavior information based on a result of the similarity determination, and a behavior information protecting unit that protects the behavior information based on the selected protection level. The server includes a behavior history information recording unit that records the behavior information as behavior history information, a determining unit that determines a request source of the behavior history information, an access right database unit that selects an access right corresponding to the determined request source, and an information provision processing unit that provides the requested behavior history information when it is determined that the requested behavior history information has a protection level in which access is permitted by the access right corresponding to the request source based on the access right corresponding to the request source and the protection level of the requested behavior history information.

In the present technology, an information terminal generates behavior information. Analysis of a behavior pattern based on the generated behavior information, a similarity determination of the analyzed behavior pattern and a protection target behavior history pattern, selection of a protection level of behavior information based on the similarity determination result, and protection of the behavior information according to the selected protection level are performed by the information terminal or the server. Further, when the behavior history information is requested, a request source is determined, and an access right is selected. When the requested behavior history information has a protection level in which access is permitted by the access right corresponding to the request source, the behavior history information is provided to the request source, for example, display information representing the behavior history pattern based on the behavior history information is provided to the request source. Further, when analysis of a behavior pattern based on behavior information, a similarity determination of the analyzed behavior pattern and a protection target behavior history pattern, selection of a protection level of behavior information based on the similarity determination result, and protection of the behavior information according to the selected protection level are performed by the information terminal, for example, the server acquires behavior history patterns from protection target behavior history pattern database units of information terminals, integrates the behavior history patterns, and registers the integrated database in the information terminals.

Further, a program according to an embodiment of the present technology is a program which can be provided by a storage medium such as an optical disc, a magnetic disk, and a semiconductor memory or a communication medium such as a network, which is provided in a general-purpose computer which can execute various program codes in a compute readable form. By providing the program in a computer readable form, processing according to the program can be implemented on the computer.

According to the embodiments of the present technology, behavior information is generated, and a protection level of the behavior information is selected based on a similarity determination of a behavior pattern analyzed based on the behavior information and a protection target behavior history pattern. In addition, protection of the behavior information is performed according to the selected protection level. Accordingly, behavior information desired to be concealed can be easily and appropriately protected.

### BRIEF DESCRIPTION OF THE DRAWINGS

FIG. 1 is a diagram illustrating a configuration of an information processing apparatus;

FIG. 2 is a flowchart illustrating an operation of the information processing apparatus;

FIG. 3 is a flowchart illustrating an operation of creating a database of a protection target behavior history pattern;

FIG. 4 is a diagram illustrating a configuration of an information processing system;

FIG. 5 is a flowchart illustrating an operation of an information terminal in an information processing system;

FIG. 6 is a flowchart illustrating an operation of a server in an information processing system;

FIG. 7 is a diagram illustrating another configuration of an information processing system;

FIG. 8 is a diagram illustrating a configuration of an information processing system that shares and protects behavior history information; and

FIG. 9 is a flowchart illustrating a configuration of an information processing system that shares and protects behavior history information.

### DETAILED DESCRIPTION OF THE EMBODIMENT(S)

Hereinafter, embodiments for embodying the present technology will be described. In the present technology, behavior history information which an individual desires to conceal, such as behavior history information including personal information such as a location of his or her home, is automatically protected. Further, in protection of behavior history information, habitual behavior patterns are determined, and protection of behavior history information is performed based on the determination result. A description will be made in the following order:

1. Configuration of Information Processing Apparatus

2. Operation of Information Processing Apparatus

3. Another Operation of Information Processing Apparatus

4. Configuration of Information Processing System

5. Operation of Information Terminal

6. Another Configuration and Operation of Information Processing System

7. Another Configuration and Operation of Information Processing System

### <1. Configuration of Information Processing Apparatus>

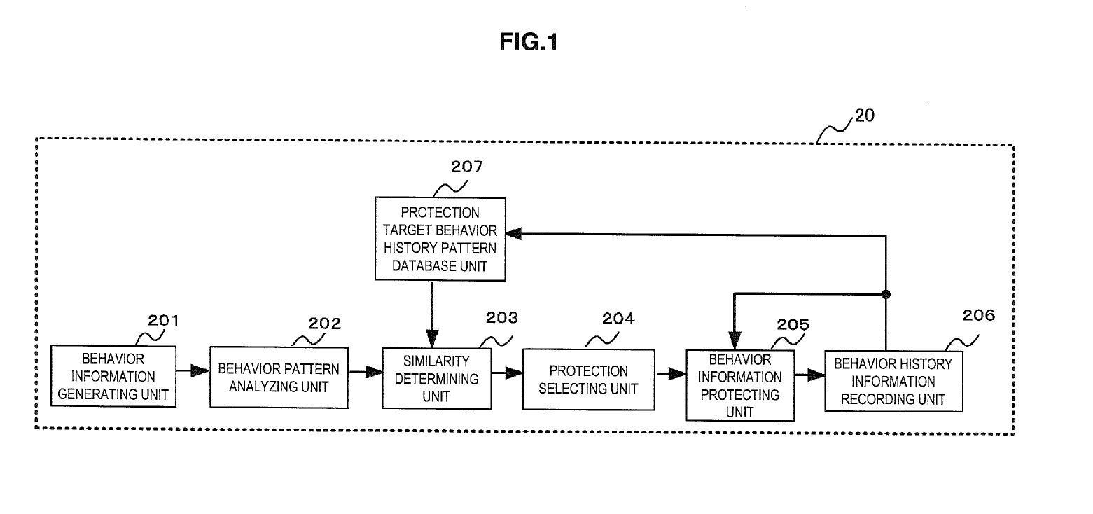

FIG. 1 illustrates a configuration of an information processing apparatus according to an embodiment of the present technology. An information processing apparatus 20 includes a behavior information generating unit 201, a behavior pattern analyzing unit 202, a similarity determining unit 203, a protection selecting unit 204, a behavior information protecting unit 205, a behavior history information recording unit 206, and a protection target behavior history pattern database (DB) unit 207.

The behavior information generating unit 201 is configured with a position detecting sensor that detects a current position based on a received radio signal, an acceleration sensor, a microphone, and the like. For example, the position detecting sensor receives a positioning signal using a global positioning system (GPS), and detects a current position and a time. The current position and a time may be detected using a signal received from a base station of a mobile telephone, or a current position may be detected by acquiring position information of a router based on an address included in a signal received from the router in WiFi (wireless fidelity) or the like. The acceleration sensor detects a motion of an information processing apparatus, and can estimate a moving status, such as whether a user is walking or a user is moving by an electric train. The moving status may be estimated with a high degree of accuracy using an ambient sound collected by a microphone as well as a motion. The behavior information generating unit 201 generates behavior information representing a current position, a moving status, or the like based on a signal from the position detecting sensor, the acceleration sensor, the microphone, or the like, and then outputs the generated behavior information to the behavior pattern analyzing unit 202. The behavior information generating unit 201 generates behavior information at predetermined time intervals so that a moving path or the like can be determined based on the behavior information, and includes time information in the behavior information.

The behavior pattern analyzing unit 202 analyzes a behavior pattern based on the behavior information generated by the behavior information generating unit 201. The behavior pattern analyzing unit 202 analyzes the behavior pattern such as a moving path on which the user is traveling, a behavior that the user is performing and, a time slot in which the user is performing the behavior, or the like, based on the behavior information, and then outputs the analysis result to the similarity determining unit 203.

The similarity determining unit 203 determines whether or not the behavior pattern analyzed by the behavior pattern analyzing unit 202 is similar to a behavior history pattern of a protection target registered in the protection target behavior history pattern database unit 207, and then outputs the determination result to the protection selecting unit 204. For example, the similarity determining unit 203 determines similarity between behavior patterns using features of behavior patterns. One feature of the behavior pattern may be used, and when many features are used for determination, the behavior patterns can be determined in detail.

For example, similarity in a moving path, similarity in a time slot in which behavior is recorded, similarity in a moving status, or the like may be used as the feature of the behavior pattern. The moving path may be obtained based on a history of a position represented by the behavior information. The time slot is not limited to a time unit but may be a date unit, a week unit, a month unit, or the like. In addition, more features as well as the above features may be used. In determination of similarity, for example, a path width is set to a moving path represented by the protection target behavior history pattern, and when a moving path represented by the behavior pattern is included in the set path width, it is determined that there is a similarity. Alternatively, a distance difference between the moving path represented by the behavior pattern and the moving path represented by the protection target behavior history pattern may be used, and in this case, when the distance difference is smaller than a threshold value, it may be determined that the moving paths are similar. Alternatively, when a time difference between a time represented by the behavior pattern and a time represented by the protection target behavior history pattern is smaller than a threshold value, it may be determined that time slots are similar.

The protection selecting unit 204 selects a protection level of the behavior information based on the similarity determination result of the behavior pattern. For example, when it is determined that there is a similarity, the protection selecting unit 204 selects a protection level to protect the behavior information. However, when it is determined that there is no similarity, the protection selecting unit 204 selects a protection level not to protect the behavior information. The protection selecting unit 204 outputs the protection level selected based on the similarity determination result of the behavior pattern to the behavior information protecting unit 205.

The behavior information protecting unit 205 performs protection of the behavior information according to the selected protection level. When the protection level is selected to protect the behavior information, the behavior information protecting unit 205 discloses the behavior information only to the user himself or a previously set person. The behavior information protecting unit 205 may encrypt the behavior information to increase confidentiality of the behavior information. However, when the protection level is selected not to protect the behavior information, the behavior information protecting unit 205 allows the behavior information to be disclosed to the general public.

The behavior information protecting unit 205 records the behavior information protected according to the selected protection level in the behavior history information recording unit 206 as behavior history information. Further, the behavior information protecting unit 205 may change the protection level of the behavior history information recorded in the behavior history information recording unit 206. For example, the behavior information is sequentially processed and then recorded in the behavior history information recording unit 206. Here, when it is determined that the behavior pattern is similar to the protection target behavior history pattern during behavior, the protection level of the behavior information of the behavior pattern before it is determined there is a similarity in a series of behavior patterns is allowed to be changed, and thus behavior information of a series of behavior patterns can be protected. Further, when the user or the like designates a new protection level, the protection level of the recorded behavior history information may be changed to the designated protection level.

The protection target behavior history pattern database unit 207 registers a behavior history pattern of a protection target. For example, the protection target behavior history pattern database unit 207 performs a search based on position information representing a protection target area or a protection target spot (hereinafter referred to simply as a “protection target area”) designated by the user, and selects behavior history information representing the protection target area from the past behavior history information. In addition, the behavior history pattern is analyzed based on the selected behavior history information, and the analysis result is registered in the database. In this case, by inputting the position information representing the position the user desires to protect, the behavior history pattern of the protection target can be registered in the database.

The protection target behavior history pattern database unit 207 may update the database with the update of the behavior history information, and in this case, the database can respond to the change.

Furthermore, the protection target behavior history pattern database unit 207 may change a threshold value used for the similarity determination according to the accuracy of the protection target behavior history pattern. For example, the protection target behavior history pattern may be decided by statistically processing the behavior history information representing the protection target area. In this case, when the amount of behavior history information representing the protection target area is large, it is assumed that the protection target behavior history pattern can represent the behavior history information to be protected with a high degree of accuracy, compared to when the amount of behavior history information representing the protection target area is small. Thus, when the amount of behavior history information used to decide the protection target behavior history pattern is small, a large path width can be set to the moving path represented by the protection target behavior history pattern, and so a determination that there is a similarity is likely to be made. As a result, it is possible to prevent the behavior history information to be protected from being unprotected. Similarly, when the amount of behavior history information used to decide the protection target behavior history pattern is small, even when a distance difference between the moving path represented by the behavior pattern and the moving path represented by the protection target behavior history pattern is large, a determination that there is a similarity is likely to be made. As a result, it is possible to prevent the behavior history information to be protected from being unprotected.

FIG. 1 illustrates a configuration in which the behavior information is protected and then recorded in the behavior history information recording unit 206. However, all behavior information acquired by the behavior information generating unit 201 may be recorded in the behavior history information recording unit as the behavior history information, and then protection of the behavior history information may be performed as described above.

### <2. Operation of Information Processing Apparatus>

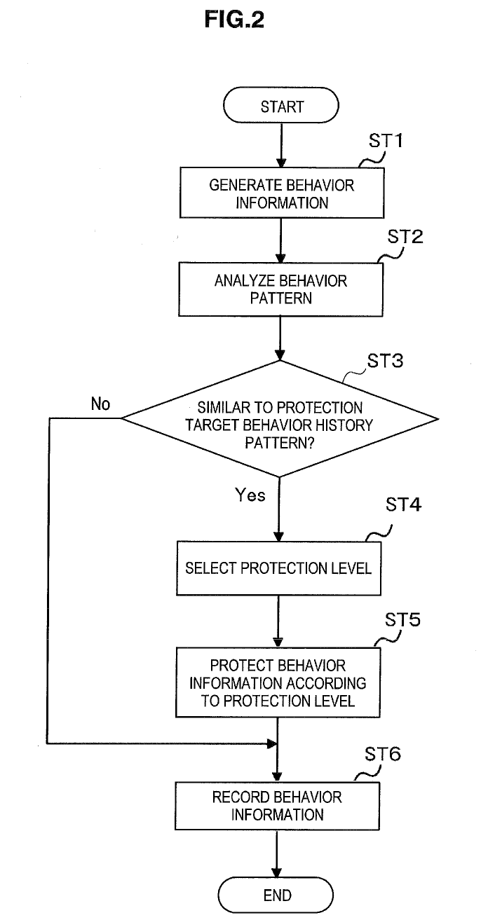

FIG. 2 is a flowchart illustrating an operation of the information processing apparatus. In step ST1, the information processing apparatus 20 generates behavior information. The behavior information generating unit 201 of the information processing apparatus 20 generates behavior information representing a current position, a moving status, or the like using a position detecting sensor, an acceleration sensor, a microphone, or the like, and then the process proceeds to step ST2.

In step ST2, the information processing apparatus 20 analyzes a behavior pattern. The behavior pattern analyzing unit 202 of the information processing apparatus 20 analyzes a behavior pattern such as a moving path on which the user is traveling, a behavior that the user is performing, a time slot in which the user is performing the behavior, or the like, based on the behavior information generated in step ST1, and then the process proceeds to step ST3.

In step ST3, the information processing apparatus 20 determines whether or not the behavior pattern is similar to the protection target behavior history pattern. The similarity determining unit 203 of the information processing apparatus 20 determines whether or not the behavior pattern analyzed in step ST2 is similar to each protection target behavior history pattern of the protection target behavior history pattern database unit 207, for example, based on the feature of the behavior pattern. Here, when it is determined that the behavior pattern is similar to the protection target behavior history pattern, the process proceeds to step ST4, whereas, when it is determined that the behavior pattern is not similar to the protection target behavior history pattern, the process proceeds to step ST6.

In step ST4, the information processing apparatus 20 selects a protection level. Since it is determined that the behavior pattern is similar to the protection target behavior history pattern, the protection selecting unit 204 of the information processing apparatus 20 selects a protection level to protect the behavior information of the behavior pattern, and then the process proceeds to step ST5.

In step ST5, the information processing apparatus 20 protects the behavior information according to the protection level. The behavior information protecting unit 205 of the information processing apparatus 20 protects the behavior information according to the protection level set in step ST4, and then the process proceeds to step ST6.

In step ST6, the information processing apparatus 20 records the behavior information. The behavior history information recording unit 206 of the information processing apparatus 20 records the behavior information in a recording medium such as a hard disk drive or a semiconductor memory as the behavior history information.

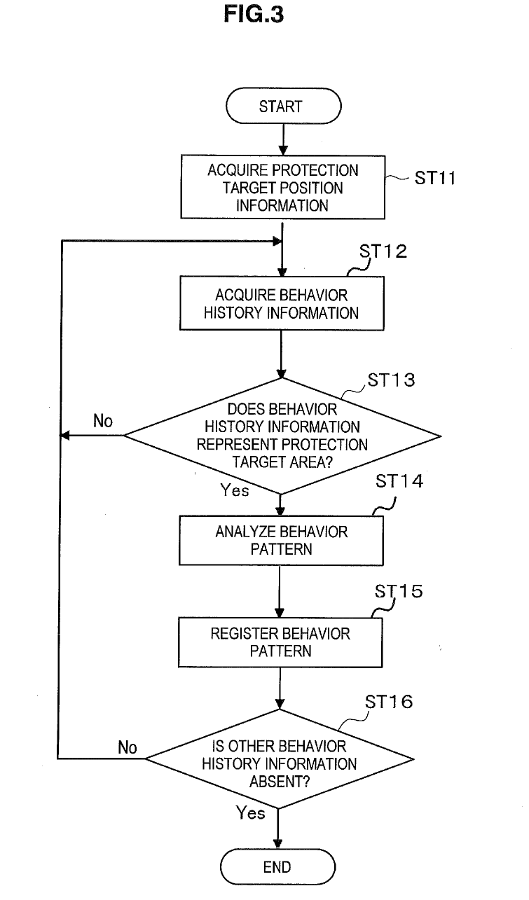

Next, an operation of creating a database of a protection target behavior history pattern will be described with reference to a flowchart of FIG. 3. In step ST11, the protection target behavior history pattern database unit 207 acquires protection target position information. When the user designates the protection target area or the protection target spot, the protection target behavior history pattern database unit 207 acquires protection target position information representing the designated protection target area, and then the process proceeds to step ST12.

In step ST12, the protection target behavior history pattern database unit 207 acquires behavior history information. The protection target behavior history pattern database unit 207 acquires behavior history information recorded in the behavior history information recording unit 206, and then the process proceeds to step ST13.

In step ST13, the protection target behavior history pattern database unit 207 determines whether or not the behavior history information represents the protection target area. When the acquired behavior history information represents the position within the protection target area, for example, when the behavior history information represents passing of the protection target area or when the behavior history information represents the position within the protection target area as a departure point or an arrival point, the protection target behavior history pattern database unit 207 causes the process to proceed to step ST14. Further, when the acquired behavior history information represents the position within the protection target area, the protection target behavior history pattern database unit 207 causes the process to return to step ST12, and then acquires the next behavior history information.

In step ST14, the protection target behavior history pattern database unit 207 analyzes the behavior pattern. The protection target behavior history pattern database unit 207 analyzes the behavior pattern based on the behavior history information representing the position within the protection target area, and then the process proceeds to step ST15.

In step ST15, the protection target behavior history pattern database unit 207 registers the behavior pattern in the database. The protection target behavior history pattern database unit 207 registers the analyzed behavior pattern in the database as the protection target behavior history pattern, and then the process proceeds to step ST16.

In step ST16, the protection target behavior history pattern database unit 207 determines whether there is no other behavior history information. When there is behavior history information which is not acquired yet among behavior history information recorded in the behavior history information recording unit 206, the protection target behavior history pattern database unit 207 causes the process to return to step ST12, acquires new behavior history information, and repeats the above-described process. Thereafter, when all behavior history information recorded in the behavior history information recording unit 206 is acquired and there is no other behavior history information, the protection target behavior history pattern database unit 207 finishes the process.

The protection target behavior history pattern database unit 207 may update the database each time new behavior information is recorded in the behavior history information recording unit 206 or each time new behavior information is recorded a predetermined number of times. In this case, the database can be constantly kept updated.

As described above, in the information processing apparatus 20, the protection level of the behavior information of the behavior pattern similar to the protection target behavior history pattern can be set to be high, and it is possible to protect the behavior history information representing the behavior pattern which passes through the protection target area set by the user in a predetermined time slot, or leaves or arrives at the position of the protection target area in a predetermined time slot. For example, it is possible to protect behavior history information representing a habitual behavior pattern such as a pattern in which a user moves from a station A to a station B by electric train in a night time slot and then returns by walking a regular route.

Thus, according to the present technology, behavior history information of a behavior pattern desired to be concealed can be automatically protected even if the user does not explicitly determine whether or not to protect each time. Further, it is possible to prevent information leakage which may occur due to a mistake that the user forgets to protect behavior history information desired to be originally protected. In addition, when protection of behavior history information is performed in real time, even when an information processing apparatus is lost, a risk of information leakage can be reduced.

### <3. Another Operation of Information Processing Apparatus>

Protection of behavior history information is not limited to the above-described operation, and setting of a protection target area, a similarity determination criterion, a protection level selecting criterion, or a degree of a protection level may be changed according to behavior history information to be protected.

Next, an example in which confidentiality on behavior history information associated with a home is set to be higher than confidentiality on behavior history information associated with a company or a school will be described.

When a protection target area is set on a home, the protection target behavior history pattern database unit 207 sets the protection target area to be larger than an area for a company or a school. When the protection target area is set in this way, the protection target area on the home is set to be large. Thus, it is possible to make it more difficult to estimate the position of the home than to estimate the position of a company or a school when the position is estimated based on behavior history information open to the public.

The similarity determining unit 203 may perform setting so that a determination that there is a similarity is more likely to be made when a protection target behavior history pattern on a home is used compared to when a protection target behavior history pattern on a company or a school is used. For example, when a path width is set to a protection target behavior history pattern, a path width on a moving path related to a home is set to be large. Further, when a distance difference between a moving path represented by a behavior pattern and a moving path of a protection target behavior history pattern is used, a threshold value on a moving path on a home is set to be large. In this case, even when the moving path represented by the behavior pattern is slightly away from the moving path up to a home, since behavior history information related to this moving path is protected, it is possible to make it more difficult to estimate the position of a home than to estimate the position of a company or a school.

The protection selecting unit 204 may set a protection level on a home to be higher than a protection level on a company or a school. The protection selecting unit 204 may adjust the protection level according to a similarity. For example, the similarity determining unit 203 determines that a similarity is high when an error in a position, a time, or the like between a behavior pattern and a protection target behavior history pattern is small but determines that a similarity is low when an error is large. The protection selecting unit 204 selects a high protection level when it is determined that a similarity is high but selects a low protection level when it is determined that a similarity is low. For example, when a high protection level is set, the behavior information protecting unit 205 inhibits behavior information (behavior history information) from being disclosed to a person other than the user himself. Further, when a high protection level is set, the behavior information protecting unit 205 may encrypt information to increase confidentiality of behavior information (behavior history information) having a high protection level or may replace information with fake information. As the protection level is lowered, the behavior information protecting unit 205 may reduce the limitation of the disclosure of behavior information (behavior history information) and disclose behavior information (behavior history information), for example, only to a previously set person. In addition, the behavior information protecting unit 205 is not limited to the above-described operation and may perform various protection operations.

The protection selecting unit 204 sets the protection level on a home to be higher than the protection level on a company or a school. Thus, for example, even when similarity determination results of behavior patterns are equal, behavior information (behavior history information) associated with a home is not open to the public at all, and behavior information (behavior history information) associated with a company or a school may be encrypted and then disclosed to the public.

Further, when a new protection level is designated by the user or the like, the behavior information protecting unit 205 may allow the protection level of the recorded behavior history information to be changed to the designated protection level. In addition, an extent to which the protection level of the recorded behavior history information is traced and made changeable may be set according to the protection level. For example, by increasing a changeable time period with the increment in the protection level, behavior history information desired to be protected with a high protection level can be more reliably protected.

### <4. Configuration of Information Processing System>

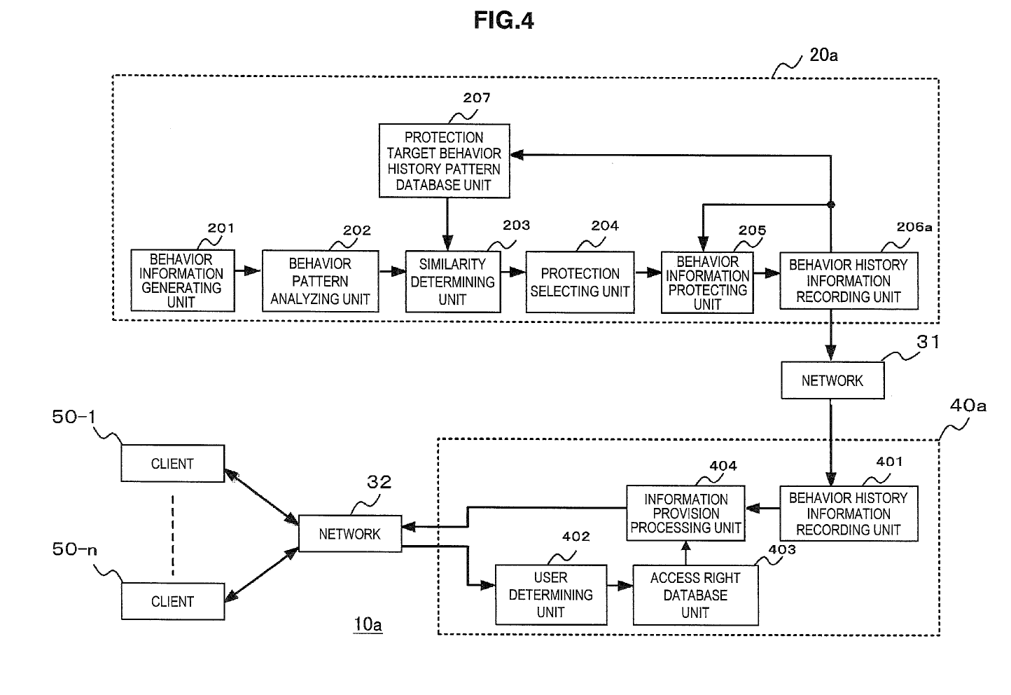

Next, an information processing system that allows behavior history information to be shared while protecting behavior history information using an information processing apparatus will be described. FIG. 4 illustrates a configuration of an information processing system using an information processing apparatus as an information terminal. In the information processing system 10a, an information processing apparatus 20a which is an information terminal is connected to a server 40a via a network 31. The server 40a is connected to clients 50-1 to 50-n via a network 32. In FIG. 4, the network 31 and the network 32 are illustrated as separate networks but may be the same network. A variety of networks such as a local area network (LAN), a wide area network (WAN), WiFi, or a 3G (3rd Generation) network may be used as the network.

The information processing apparatus 20a corresponds to the information processing apparatus 20 illustrated in FIG. 1, and a different portion will be described. A behavior history information recording unit 206a of the information processing apparatus 20a records behavior information protected according to the protection level selected by a behavior information protecting unit 205 in a recording medium as behavior history information. The behavior history information recording unit 206a is configured to perform communication with the server 40a via the network 31. The behavior history information recording unit 206a performs communication with the server 40a and records new behavior information in a behavior history information recording unit 401 of the server 40a each time new behavior information is recorded, each time new behavior information is recorded a predetermined number of times, at predetermined intervals, or each time a predetermined time elapses. Alternatively, the behavior history information recording unit 206a may perform communication with the server 40a as described above and perform a process of causing behavior history information of the information processing apparatus 20a recorded in the behavior history information recording unit 401 to match behavior history information recorded in the behavior history information recording unit 206a of the information processing apparatus 20a.

Furthermore, a communication unit (not illustrated) that performs communication with the server 40a via the network 31 may be disposed at the stage subsequent to the behavior information protecting unit 205. In this case, behavior information may be recorded in the behavior history information recording unit 401 of the server 40a without being recorded in the behavior history information recording unit 206a.

The server 40a includes the behavior history information recording unit 401, a user determining unit 402, an access right database unit 403, and an information provision processing unit 404.

The behavior history information recording unit 401 records behavior information (behavior history information) supplied from the information processing apparatus 20a. The behavior history information recorded in the behavior history information recording unit 401 is read by the information provision processing unit 404 which will be described later.

The user determining unit 402 determines a client which has requested behavior history information, and supplies a determination result to the access right database unit 403.

The access right database unit 403 includes an access right database, in which an access permission level is associated with a client, registered therein in advance. The access right database unit 403 determines an access permission level on a client which has requested behavior history information with reference to the access right database, and outputs the determination result to the information provision processing unit 404.

The information provision processing unit 404 reads the behavior history information requested by the client from the behavior history information recording unit 401. Then, the information provision processing unit 404 outputs the read behavior history information to a client of a request source. For example, the information provision processing unit 404 generates display information, which causes a behavior pattern to be displayed by a diagram or a table, based on the behavior history information, and then transmits the generated display information to the client that has requested the behavior history information. Further, the information provision processing unit 404 supplies information according to the access permission level of the determined client. For example, when the protection level of the behavior history information requested by the client is a protection level in which provision of information is permitted at the access permission level of the client, the information provision processing unit 404 reads the behavior history information requested by the client from the behavior history information recording unit 401. Further, the display information is generated based on the read behavior history information. Further, when the behavior history information requested by the client has a level higher than the protection level in which provision of information is permitted at the access permission level of the client, the information provision processing unit 404 generates display information representing that access is not permitted or reads replaced fake information and generates display information.

### <5. Operation of Information Terminal>

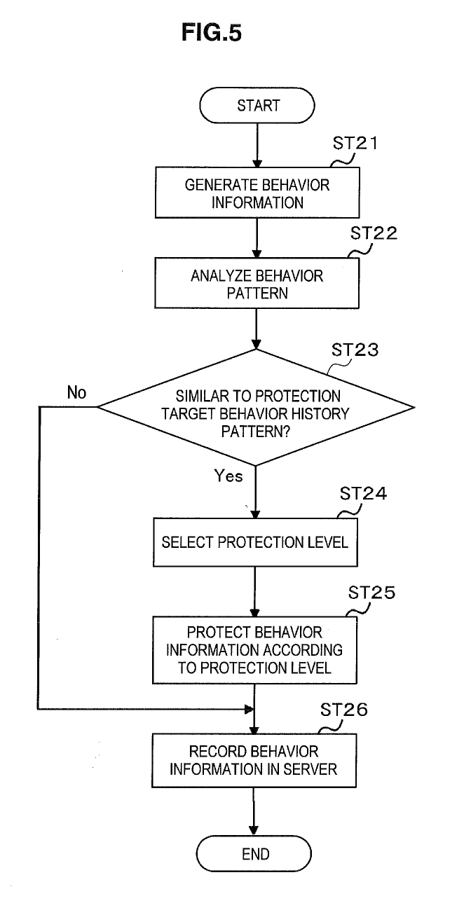

FIG. 5 is a flowchart illustrating an operation of an information terminal in an information processing system. In step ST21, the information processing apparatus 20a generates behavior information. The behavior information generating unit 201 of the information processing apparatus 20a generates behavior information representing a current position, a moving status, or the like using a position detecting sensor, an acceleration sensor, the microphone, or the like, and then the process proceeds to step ST22.

In step ST22, the information processing apparatus 20a analyzes the behavior pattern. The behavior pattern analyzing unit 202 of the information processing apparatus 20a analyzes the behavior pattern such as a moving path on which the user is traveling, a behavior that the user is performing, a time slot in which the user is performing the behavior, or the like, based on the behavior information generated in step ST21, and then the process proceeds to step ST23.

In step ST23, the information processing apparatus 20a determines whether or not the behavior pattern is similar to the protection target behavior history pattern. The similarity determining unit 203 of the information processing apparatus 20a determines whether or not the behavior pattern analyzed in step ST22 is similar to the protection target behavior history pattern, for example, based on the feature of the behavior pattern. Here, when it is determined that the behavior pattern is similar to the protection target behavior history pattern, the process proceeds to step ST24, whereas when it is determined that the behavior pattern is not similar to the protection target behavior history pattern, the process proceeds to step ST26.

In step ST24, the information processing apparatus 20a selects a protection level. The protection selecting unit 204 of the information processing apparatus 20a selects the protection level based on the similarity determination result of the behavior pattern, and then the process proceeds to step ST25.

In step ST25, the information processing apparatus 20a protects the behavior information according to the protection level. The behavior information protecting unit 205 of the information processing apparatus 20a protects the behavior information according to the protection level set in step ST24, and then the process proceeds to step ST26.

In step ST26, the information processing apparatus 20a records the behavior information in the server. The behavior history information recording unit 206a of the information processing apparatus 20a performs communication with the server 40a via the network 31, and records the behavior history information recorded in the behavior history information recording unit 206a in the behavior history information recording unit 401 of the server 40a.

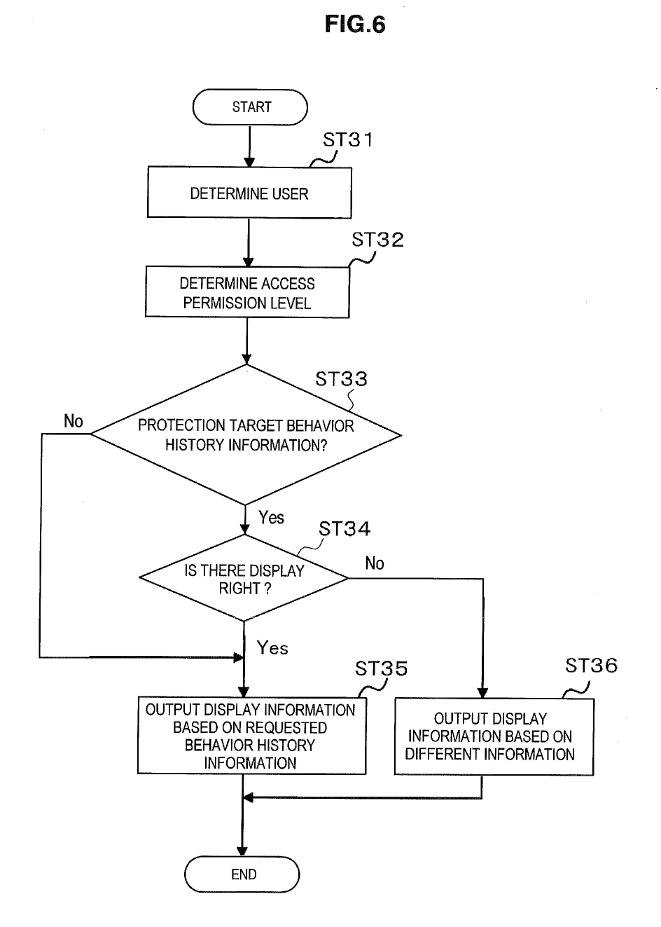

FIG. 6 is a flowchart illustrating an operation of a server in an information processing system. In step ST31, the server 40a performs a user determination. The user determining unit 402 of the server 40a determines a client which has requested behavior history information, and then the process proceeds to step ST32.

In step ST32, the server 40a determines an access permission level. The access right database unit 403 of the server 40a determines the access permission level on the client which has requested the behavior history information with reference to the access right database, and then the process proceeds to step ST33.

In step ST33, the server 40a determines whether or not the behavior history information requested by the client corresponds to protection target behavior history information. The information provision processing unit 404 of the server 40a determines whether or not the behavior history information requested by the client corresponds to behavior history information of the protection target. When it is determined that the behavior history information requested by the client corresponds to behavior history information of the protection target, the information provision processing unit 404 causes the process to proceed to step ST34. However, when the behavior history information requested by the client does not correspond to behavior history information of the protection target, the process proceeds to step ST35.

In step ST34, the server 40a determines that there is a display right. When the protection level of the behavior history information requested by the client is within a range of the protection level in which provision of information is permitted at the access permission level of the client, the information provision processing unit 404 determines that there is a display right, and then the process proceeds to step ST35. Further, when the behavior history information requested by the client has a level higher than the protection level in which provision of information is permitted at the access permission level of the client, the information provision processing unit 404 determines that there is no display right, and then the process proceeds to step ST36.

In step ST35, the server 40a outputs display information based on the requested behavior history information. The information provision processing unit 404 reads the behavior history information requested by the client from the behavior history information recording unit 401. Further, the information provision processing unit 404 generates display information based on the read behavior history information, outputs the generated display information to the client which has requested, and then finishes the process.

In step ST36, the server 40a outputs display information based on different information. The information provision processing unit 404 generates display information based on information different from the behavior history information requested by the client, outputs the generated display information to the client making the request, and then finishes the process. For example, the different information is used to output display information representing no permission or display information based on replaced fake information.

Using this information processing system, it is possible to individually set what behavior history information will be shared with which clients. Thus, when behavior history information is shared, behavior history information desired to be concealed can be automatically protected, and behavior history information can be safely shared.

Further, by changing protection and display methods according to behavior history information, an extent to which behavior history information is shared can be automatically changed according to a sharing partner. For example, it is possible to share behavior history information until the user arrives at the closest station with a company colleague, and it is possible to share behavior history information until the user arrives at home with a close friend. Furthermore, information representing that it is not permitted to browse is simply displayed to a client that is not permitted to share, but it is possible to individually set whether or not to display fake information for each behavior history information and each client.

### <6. Another Configuration and Operation of Information Processing System>

Meanwhile, an information terminal which is easy to carry is desirable as the information terminal that generates the behavior information. Further, an information terminal having low power consumption is desirable. However, when an information terminal performs analysis of a behavior pattern, a similarity determination, selection of a protection method, and protection of behavior history information, an information terminal having a high processing performance is necessary in order to perform these processes, and so it is difficult to easily reduce power consumption. In this regard, a configuration and operation of an information processing system capable of simplifying a configuration of an information terminal and reducing power consumption of the information terminal by disposing a behavior pattern analyzing unit, a similarity determining unit, a protection selecting unit, and a behavior information protecting unit in a server will be described.

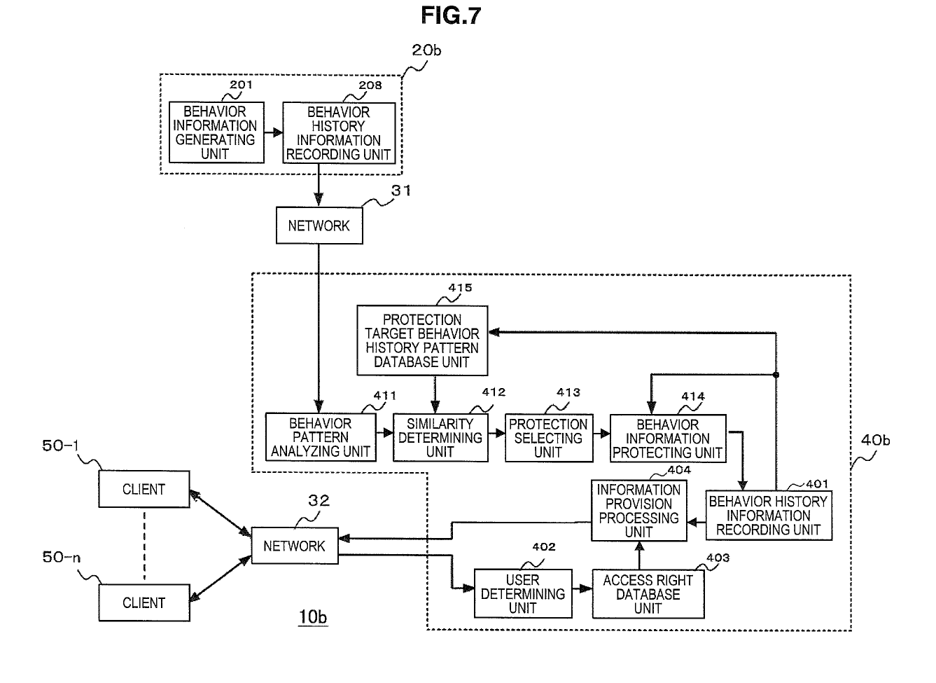

FIG. 7 illustrates another configuration of an information processing system. In an information processing system 10b, an information processing apparatus 20b which is an information terminal is connected with a server 40b via a network 31. The server 40b is connected with clients 50-1 to 50-n via a network 32. In FIG. 7, the network 31 and the network 32 are illustrated as separate networks but may be the same network. A variety of networks such as a LAN, a WAN, WiFi, or a 3G network may be used as the network.

The information processing apparatus 20b includes a behavior information generating unit 201 and a behavior history information recording unit 208.

The behavior information generating unit 201 is configured with a position detecting sensor that detects a current position based on a received radio signal, an acceleration sensor, a microphone, and the like as described above. The behavior information generating unit 201 detects a current position by the position detecting sensor. Further, the behavior information generating unit 201 estimates a moving status based on a signal from the acceleration sensor or the microphone. The behavior information generating unit 201 generates behavior information representing the detected current position, the estimated moving status, or the like, and records the behavior information in the behavior history information recording unit 208.

The behavior history information recording unit 208 records the behavior information generated by the behavior information generating unit 201 as behavior history information. The behavior history information recording unit 208 is configured to perform communication with the server 40b via the network 31. The behavior history information recording unit 208 performs communication with the server 40b and transmits the behavior history information or new behavior information to the server 40b each time new behavior information is recorded, each time new behavior information is recorded a predetermined number of times, at predetermined intervals, or each time a predetermined time elapses.

The server 40b includes a behavior history information recording unit 401, a user determining unit 402, an access right database unit 403, and an information provision processing unit 404, similarly to the server 40a described above. Further, in order to set a protection level of behavior information, the server 40b further includes a behavior pattern analyzing unit 411, a similarity determining unit 412, a protection selecting unit 413, a behavior information protecting unit 414, and a protection target behavior history pattern database (DB) unit 415.

The behavior pattern analyzing unit 411 analyzes a behavior pattern based on behavior information (behavior history information) supplied from the information processing apparatus 20b. The behavior pattern analyzing unit 411 analyzes the behavior pattern such as a moving path on which the user is traveling, a behavior that the user is performing, a time slot in which the user is performing the behavior, or the like, based on the behavior information (behavior history information), similarly to the behavior pattern analyzing unit 202. Then, the behavior pattern analyzing unit 411 outputs the analysis result to the similarity determining unit 412.

The similarity determining unit 412 determines whether or not the behavior pattern analyzed by the behavior pattern analyzing unit 411 is similar to a protection target behavior history pattern registered in the protection target behavior history pattern database unit 415, similarly to the similarity determining unit 203. The similarity determining unit 412 outputs the determination result to the protection selecting unit 413.

The protection selecting unit 413 selects a protection level of the behavior information (behavior history information) based on the similarity determination result of the behavior pattern, similarly to the protection selecting unit 204. The protection selecting unit 413 outputs the protection level selected based on the similarity determination result of the behavior pattern to the behavior information protecting unit 414.

The behavior information protecting unit 414 performs protection of the behavior information (behavior history information) according to the selected protection level, similarly to the behavior information protecting unit 205. When the protection level is selected to protect the behavior information (behavior history information), the behavior information protecting unit 414 discloses the behavior information (behavior history information) only to the user himself or herself or a previously set person. The behavior information protecting unit 414 may encrypt the behavior information to increase confidentiality of the behavior information (behavior history information). However, when the protection level is selected not to protect the behavior information (behavior history information), the behavior information protecting unit 414 allows the behavior information (behavior history information) to be disclosed to the general public. Further, when the protection level is set to be high according to a similarity, inhibition of the disclosure, encryption of information, replacement with fake information, and the like are performed. Further, as the protection level is lowered, the limitation of the disclosure of behavior information (behavior history information) is mitigated. The behavior information protecting unit 414 records the behavior information (behavior history information) protected according to the selected protection level in the behavior history information recording unit 401.

The protection target behavior history pattern database unit 415 registers a behavior pattern of a protection target, similarly to the protection target behavior history pattern database unit 207. For example, the protection target behavior history pattern database unit 415 performs a search based on position information representing a protection target area designated by the user, and selects behavior history information representing the protection target area from the past behavior history information measured so far. In addition, the behavior history pattern is analyzed based on the selected behavior history information, and the analysis result is registered in the database as a protection target behavior history pattern.

The user determining unit 402 determines a client which has requested behavior history information, and supplies a determination result to the access right database unit 403.

The access right database unit 403 includes an access right database, in which an access permission level associated with a client is registered in advance. The access right database unit 403 determines an access permission level on a client which has requested behavior history information with reference to the access right database, and outputs the determination result to the information provision processing unit 404.

The information provision processing unit 404 reads the behavior history information requested by the client from the behavior history information recording unit 401. Then, the information provision processing unit 404 generates display information based on the read behavior history information. The information provision processing unit 404 generates display information according to the access permission level of the determined client, and then transmits the generated display information to the client that has requested the behavior history information.

In the information processing system having the above-described configuration, the information processing apparatus 20b which is the information terminal performs the processes of steps ST1 and step ST6 illustrated in FIG. 2 and the process of step ST26 illustrated in FIG. 5, and outputs behavior information (behavior history information) to the server 40b. The server 40b performs the processes of steps ST2 to step ST6 illustrated in FIG. 2, and records the protected behavior information (behavior history information) in the behavior history information recording unit 401. Thereafter, the server 40b performs the processes of steps ST31 to ST36 illustrated in FIG. 6, and transmits display information generated based on behavior history information of a protection level corresponding to an access permission level of the client to the client at the client's request.

When the information processing system is configured as described above, the configuration of the information terminal can be simplified, and power consumption can be reduced.

### <7. Another Configuration and Operation of Information Processing System>

The above description has been made in connection with the example in which the protection level of the behavior history information generated by the individual information processing apparatus is selected in the information processing system. However, the protection level may be selected in terms of how behavior history information of other people is protected.

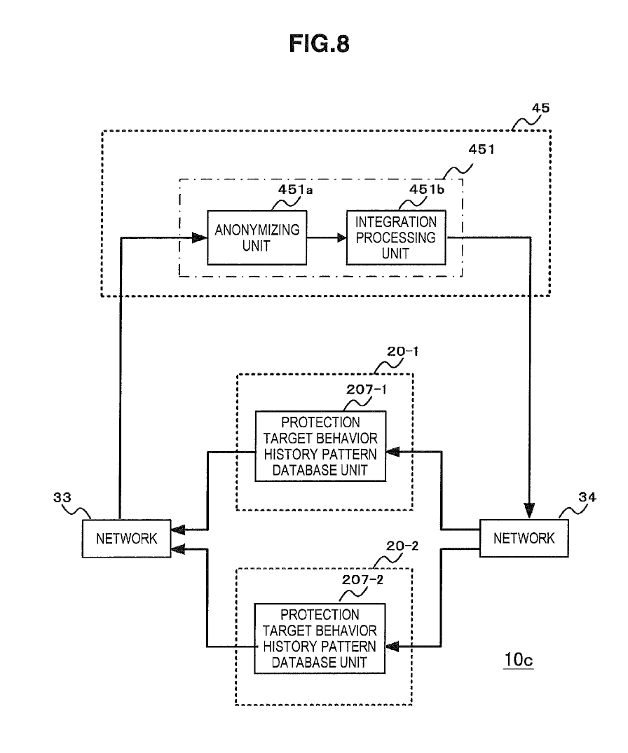

FIG. 8 illustrates a part of a configuration of an information processing system 10c that shares and protects behavior history information. FIG. 8 illustrates an example in which behavior history information is supplied by two information terminals.

A protection target behavior history pattern database unit 207-1 of an information processing apparatus 20-1 which is a first information terminal is connected with a server 45 via networks 33 and 34. Similarly, a protection target behavior history pattern database unit 207-2 of an information processing apparatus 20-2 which is a second information terminal is connected with the server 45 via the networks 33 and 34. The information processing apparatuses 20-1 and 20-2 have the same configuration as the information processing apparatus illustrated in FIG. 1 or 4, and FIG. 8 illustrates only a protection target behavior history pattern database unit.

The server 45 includes a database integrating unit 451, and the database integrating unit 451 includes an anonymizing unit 451a and an integration processing unit 451b. The server 45 has the same configuration as the server illustrated in FIG. 4, and FIG. 8 illustrates only the database integrating unit 451.

The anonymizing unit 451a anonymizes a protection target behavior history pattern. The anonymizing unit 451a anonymizes data so that it can be difficult to identify an information processing apparatus from which the server 45 has acquired a protection target behavior history pattern via the network 33.

The integration processing unit 451b integrates protection target behavior history patterns. The integration processing unit 451b integrates protection target behavior history patterns of all users using the anonymized protection target behavior history patterns. The integration processing unit 451b supplies an integrated database to each information processing apparatus, for example, the information processing apparatuses 20-1 and 20-2, via the network 34.

When the protection target behavior history pattern database is received from the server 45, the information processing apparatuses 20-1 and 20-2 update the databases stored in the protection target behavior history pattern database units 207-1 and 207-2 with the databases received from the server 45, respectively.

Anonymization of the protection target behavior history pattern is not limited to the example in which it is performed by the server 45 and may be performed by the information processing apparatus. Further, integration of the protection target behavior history patterns may be performed according to a sex or an age of a user.

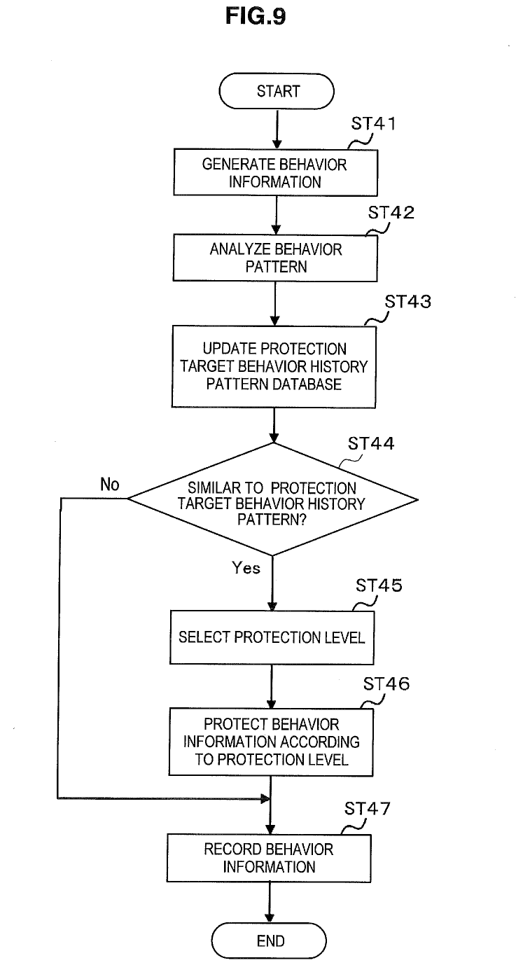

FIG. 9 illustrates an operation of an information terminal in an information processing system that shares and protects behavior history information. In step ST41, the information processing apparatus 20-1 (20-2) generates behavior information. The behavior information generating unit 201 of the information processing apparatus 20-1 (20-2) generates behavior information representing a current position, a moving status, or the like using a position detecting sensor, an acceleration sensor, a microphone, or the like, and then the process proceeds to step ST42.

In step ST42, the information processing apparatus 20-1 (20-2) analyzes a behavior pattern. The behavior pattern analyzing unit 202 of the information processing apparatus 20-1 (20-2) analyzes a behavior pattern such as a moving path on which the user is traveling, a behavior that the user is performing, a time slot in which the user is performing the behavior, or the like, based on the behavior information generated in step ST41, and then the process proceeds to step ST43.

In step ST43, the information processing apparatus 20-1 (20-2) updates data of a protection target behavior history pattern. The behavior pattern analyzing unit 202 of the information processing apparatus 20-1 (20-2) updates the database based on the behavior pattern analysis result. Further, when the database is updated based on the behavior pattern analysis result, the updated protection target behavior history pattern is output to the server 45. In addition, when a protection target behavior history pattern is received from the server 45, the information processing apparatus 20 updates the stored protection target behavior history pattern with the protection target behavior history pattern received from the server 45, and then the process proceeds to step ST44.

In step ST44, the information processing apparatus 20-1 (20-2) determines whether or not the behavior pattern is similar to the protection target behavior history pattern. The similarity determining unit 203 of the information processing apparatus 20-1 (20-2) determines whether or not the behavior pattern analyzed in step ST42 is similar to each protection target behavior history pattern of the database, for example, based on the feature of the behavior pattern. Here, when it is determined that the behavior pattern is similar to the protection target behavior history pattern, the process proceeds to step ST45, whereas when it is determined that the behavior pattern is not similar to the protection target behavior history pattern, the process proceeds to step ST47.

In step ST45, the information processing apparatus 20-1 (20-2) selects a protection level according to a similarity. The protection selecting unit 204 of the information processing apparatus 20-1 (20-2) selects a protection level based on the similarity determination result of the behavior pattern, and then the process proceeds to step ST46.

In step ST46, the information processing apparatus 20-1 (20-2) protects the behavior information according to the protection level. The behavior information protecting unit 205 of the information processing apparatus 20-1(20-2) protects the behavior information according to the protection level set in step ST45, and then the process proceeds to step ST47.

In step ST47, the information processing apparatus 20-1 (20-2) records the behavior information. The behavior history information recording unit 206 of the information processing apparatus 20-1 (20-2) records the behavior information in a recording medium such as a hard disk drive or a semiconductor memory.

As described above, when the protection target behavior history patterns of the information terminals are integrated and then the behavior history information is protected using the integrated database, anyone can more reliably protect behavior history information desired to be concealed. Thus, for example, even when the user has poor security knowledge and forgets to protect behavior history information which needs to be concealed, behavior history information can be safely protected.

Further, when integration of protection target behavior history patterns is performed according to a sex or an age, the database can be shared between people having the same sex or the same age, and so behavior history information can be protected according to a sex or an age.

Further, the information processing system and server may be configured to store each user's protection target behavior history pattern database and perform all processes excluding generation of behavior information on the server.

The servers 40a and 40b are configured to include the behavior history information recording unit 401, but the behavior history information recording unit 401 may be disposed in an external data center or the like. In this case, access to the behavior history information recording unit 401 may be made via a network or the like, and the same operation as in the example having the behavior history information recording unit 401 may be performed.

A series of processes described in this disclosure may be executed by hardware, software, or a combined configuration thereof. When a series of processes is performed by software, a program including a processing sequence is installed in a memory in a computer incorporated in dedicated hardware and then executed. Alternatively, the program may be installed in a general-purpose computer that can execute various processes and then executed.

For example, the program may be recorded in a recording medium such as a hard disk or a read only memory (ROM) in advance. Alternatively, the program may be temporarily or permanently stored (recorded) in a removable recording medium such as a flexible disk, a compact disc read only memory (CD-ROM), a magneto optical (MO) disc, a digital versatile disc (DVD), a magnetic disk, or a semiconductor memory card. The removable recording medium may be provided as so-called packet software.

Further, the program may be transmitted from a download site to the computer via a network such as a LAN or the Internet in a wired or wireless manner instead of being installed in the computer from the removable recording medium. The computer may receive the transmitted program and install the program in a recording medium such as a built-in hard disk.

The present technology should not to be interpreted to be limited to the embodiments of the above-described technology. The embodiments of the present technology disclose the present technology as the exemplary embodiments, and it should be understood that those skilled in the art can modify or replace the embodiments in a range not departing from the gist of the present technology. In other words, the claims should be considered in order to determine the gist of the present technology.

Additionally, the present technology may also be configured as below.

(1) An information processing apparatus, including:

a behavior information generating unit that generates behavior information;

a behavior pattern analyzing unit that analyzes a behavior pattern based on the behavior information;

a similarity determining unit that performs a similarity determination of the analyzed behavior pattern and a protection target behavior history pattern;

a protection selecting unit that selects a protection level of the behavior information based on a result of the similarity determination; and

a behavior information protecting unit that protects the behavior information based on the selected protection level.

(2) The information processing apparatus according to (1), further including:

a behavior history information recording unit that records the behavior information as behavior history information; and

a protection target behavior history pattern database unit that registers the protection target behavior history pattern,

wherein the protection target behavior history pattern database unit generates the protection target behavior history pattern using the behavior history information recorded in the behavior history information recording unit.

(3) The information processing apparatus according to (2),

wherein the protection target behavior history pattern database unit registers a behavior pattern as a protection target behavior history pattern based on behavior history information representing a position or an area designated by a user.

(4) The information processing apparatus according to (2) or (3),

wherein the protection target behavior history pattern database unit updates a database using protection target behavior history pattern supplied from an outside.

(5) The information processing apparatus according to any one of (2) to (4),

wherein a protection level of the behavior history information recorded in the behavior history information recording unit is changeable.

(6) The information processing apparatus according to any one of (1) to (5),

wherein the protection selecting unit selects a high protection level as similarity increases.

(7) The information processing apparatus according to any one of (1) to (6),

wherein the behavior information generating unit includes at least position information or position information and information representing a means of transportation in the behavior information together with time information.

(8) The information processing apparatus according to (7),

wherein the similarity determining unit determines similarity of a path based on the position information or determines similarity of a path based on the position information and similarity of a behavior time slot based on time information, and determines similarity of the means of transportation when the information representing the means of transportation is included in the behavior information.

(9) An information processing method, including:

generating behavior information;

analyzing a behavior pattern based on the behavior information;

performing a similarity determination of the analyzed behavior pattern and a protection target behavior history pattern;

selecting a protection level of the behavior information based on a result of the similarity determination; and

protecting the behavior information based on the selected protection level.

(10) A program for causing a computer to perform information processing and execute:

a process of generating behavior information;

a process of analyzing a behavior pattern based on the behavior information;

a process of performing a similarity determination of the analyzed behavior pattern and a protection target behavior history pattern;

a process of selecting a protection level of the behavior information based on a result of the similarity determination; and

a process of protecting the behavior information based on the selected protection level.

(11) A server, including:

a behavior history information recording unit that records behavior information, in which a behavior pattern is analyzed from behavior information generated by a terminal apparatus, and a protection level of the behavior information is selected based on a similarity determination of the analyzed behavior pattern and a protection target behavior history pattern, as behavior history information;

a determining unit that determines a request source of the behavior history information;

an access right database unit that selects an access right corresponding to the determined request source; and

an information provision processing unit that provides the requested behavior history information when it is determined that the requested behavior history information has a protection level in which access is permitted by the access right corresponding to the request source based on the access right corresponding to the request source and the protection level of the requested behavior history information.

(12) The server according to (1), further including

a database integrating unit that integrates behavior history patterns registered in protection target behavior history pattern database units of information terminals, and registers an integrated database in the protection target behavior history pattern database units of the information terminals.

(13) An information processing method, including:

determining a request source of behavior history information which is behavior information in which a behavior pattern is analyzed from behavior information generated by a terminal apparatus, and a protection level of the behavior information is selected based on a similarity determination of the analyzed behavior pattern and a protection target behavior history pattern;

selecting an access right corresponding to the determined request source; and

providing the requested behavior history information when it is determined that the requested behavior history information has a protection level in which access is permitted by the access right corresponding to the request source based on the access right corresponding to the request source and the protection level of the requested behavior history information.

(14) A program for causing a computer to perform information processing and execute:

a process of determining a request source of behavior history information which is behavior information in which a behavior pattern is analyzed from behavior information generated by a terminal apparatus, and a protection level of the behavior information is selected based on a similarity determination of the analyzed behavior pattern and a protection target behavior history pattern;

a process of selecting an access right corresponding to the determined request source; and

a process of providing the requested behavior history information when it is determined that the requested behavior history information has a protection level in which access is permitted by the access right corresponding to the request source based on the access right corresponding to the request source and the protection level of the requested behavior history information.

(15) A server configuring a part of an information processing system, the server including:

a determining unit that determines a request source of behavior history information;

an access right database unit that selects an access right corresponding to the determined request source; and

an information provision processing unit that provides the requested behavior history information when it is determined that the requested behavior history information has a protection level in which access is permitted by the access right corresponding to the request source based on the access right corresponding to the request source and the protection level of the requested behavior history information,

wherein the information processing system further includes an information terminal, and at least one of the information terminal and the server further includes
a behavior pattern analyzing unit that analyzes a behavior pattern based on the behavior information supplied from the information terminal,
a similarity determining unit that performs a similarity determination of the analyzed behavior pattern and a protection target behavior history pattern,
a protection selecting unit that selects a protection level of the behavior information based on a result of the similarity determination, and
a behavior information protecting unit that protects the behavior history information which is behavior information in which a protection level is selected based on the selected protection level.

(16) An information processing system, including:

an information terminal that generates behavior information; and

a server that provides behavior history information in response to a request,

wherein at least one of the information terminal and the server includes
a behavior pattern analyzing unit that analyzes a behavior pattern based on the behavior information,
a similarity determining unit that performs a similarity determination of the analyzed behavior pattern and a protection target behavior history pattern,
a protection selecting unit that selects a protection level of the behavior information based on a result of the similarity determination, and
a behavior information protecting unit that protects the behavior information based on the selected protection level, and

wherein the server includes
a behavior history information recording unit that records the behavior information as behavior history information,
a determining unit that determines a request source of the behavior history information,
an access right database unit that selects an access right corresponding to the determined request source, and
an information provision processing unit that provides the requested behavior history information when it is determined that the requested behavior history information has a protection level in which access is permitted by the access right corresponding to the request source based on the access right corresponding to the request source and the protection level of the requested behavior history information.

(17) The information processing system according to (16),

wherein the information terminal is provided with a behavior pattern analyzing unit that analyzes a behavior pattern based on the behavior information, a similarity determining unit that performs a similarity determination of the analyzed behavior pattern and a protection target behavior history pattern, and a protection target behavior history pattern database unit that registers the protection target behavior history pattern, and

wherein the server is provided with a database integrating unit that acquires behavior history patterns from protection target behavior history pattern database units of information terminals, integrates the behavior history patterns, and registers an integrated database in the protection target behavior history pattern database units of the information terminals.

(18) The information processing system according to (17),

wherein the database integrating unit anonymizes the behavior history patterns acquired from the protection target behavior history pattern database units of the information terminals.

(19) An information processing method performed by an information processing system including an information terminal that generates behavior information and a server that provides behavior history information in response to a request, the method including:

by at least one of the information terminal and the server,

analyzing a behavior pattern based on the behavior information;

performing a similarity determination of the analyzed behavior pattern and a protection target behavior history pattern;

selecting a protection level of the behavior information based on a result of the similarity determination; and

protecting the behavior information based on the selected protection level; and

by the server,

recording the behavior information as behavior history information;

determining a request source of the behavior history information;

selecting an access right corresponding to the determined request source; and

providing the requested behavior history information when it is determined that the requested behavior history information has a protection level in which access is permitted by the access right corresponding to the request source based on the access right corresponding to the request source and the protection level of the requested behavior history information.

In the present technology, behavior information is generated, a protection level of the behavior information is selected based on a similarity determination of a behavior pattern analyzed from the behavior information and a protection target behavior history pattern. Further, protection of the behavior information is performed according to the selected protection level. Thus, since behavior information desired to be concealed can be easily and appropriately protected, the present technology is appropriate for electronic devices such as mobile communication terminals.

The present disclosure contains subject matter related to that disclosed in Japanese Priority Patent Application JP 2011-140935 filed in the Japan Patent Office on Jun. 24, 2011, the entire content of which is hereby incorporated by reference.

What is claimed is:

1. An information processing apparatus, comprising:
a behavior information generating unit that generates behavior information;
a behavior pattern analyzing unit that analyzes a behavior pattern based on the behavior information;
a similarity determining unit that performs a similarity determination of the analyzed behavior pattern and a protection target behavior history pattern;
a protection selecting unit that selects a protection level of the behavior information based on a result of the similarity determination; and
a behavior information protecting unit that protects the behavior information based on the selected protection level.

2. The information processing apparatus according to claim 1, further comprising:
a behavior history information recording unit that records the behavior information as behavior history information; and
a protection target behavior history pattern database unit that registers the protection target behavior history pattern,
wherein the protection target behavior history pattern database unit generates the protection target behavior history pattern using the behavior history information recorded in the behavior history information recording unit.

3. The information processing apparatus according to claim 2,
wherein the protection target behavior history pattern database unit registers a behavior pattern as a protection target behavior history pattern based on behavior history information representing a position or an area designated by a user.

4. The information processing apparatus according to claim 2,
wherein the protection target behavior history pattern database unit updates a database using protection target behavior history pattern supplied from an outside.

5. The information processing apparatus according to claim 2,
wherein a protection level of the behavior history information recorded in the behavior history information recording unit is changeable.

6. The information processing apparatus according to claim 1,
wherein the protection selecting unit selects a high protection level as similarity increases.

7. The information processing apparatus according to claim 1,
wherein the behavior information generating unit includes at least position information or position information and information representing a means of transportation in the behavior information together with time information.

8. The information processing apparatus according to claim 7,
wherein the similarity determining unit determines similarity of a path based on the position information or determines similarity of a path based on the position information and similarity of a behavior time slot based on time information, and determines similarity of the means of transportation when the information representing the means of transportation is included in the behavior information.

9. An information processing method, comprising:
generating behavior information;
analyzing a behavior pattern based on the behavior information;
performing a similarity determination of the analyzed behavior pattern and a protection target behavior history pattern;
selecting a protection level of the behavior information based on a result of the similarity determination; and
protecting the behavior information based on the selected protection level.

10. A program for causing a computer to perform information processing and execute:
a process of generating behavior information;
a process of analyzing a behavior pattern based on the behavior information;
a process of performing a similarity determination of the analyzed behavior pattern and a protection target behavior history pattern;
a process of selecting a protection level of the behavior information based on a result of the similarity determination; and
a process of protecting the behavior information based on the selected protection level.

11. A server, comprising:
a behavior history information recording unit that records behavior information, in which a behavior pattern is analyzed from behavior information generated by a terminal apparatus, and a protection level of the behavior information is selected based on a similarity determination of the analyzed behavior pattern and a protection target behavior history pattern, as behavior history information;
a determining unit that determines a request source of the behavior history information;
an access right database unit that selects an access right corresponding to the determined request source; and
an information provision processing unit that provides the requested behavior history information when it is determined that the requested behavior history information has a protection level in which access is permitted by the access right corresponding to the request source based on the access right corresponding to the request source and the protection level of the requested behavior history information.

12. The server according to claim 1, further comprising
a database integrating unit that integrates behavior history patterns registered in protection target behavior history pattern database units of information terminals, and registers an integrated database in the protection target behavior history pattern database units of the information terminals.

13. An information processing method, comprising:
determining a request source of behavior history information which is behavior information in which a behavior pattern is analyzed from behavior information generated by a terminal apparatus, and a protection level of the behavior information is selected based on a similarity determination of the analyzed behavior pattern and a protection target behavior history pattern;
selecting an access right corresponding to the determined request source; and
providing the requested behavior history information when it is determined that the requested behavior history information has a protection level in which access is permitted by the access right corresponding to the request source based on the access right corresponding to the request source and the protection level of the requested behavior history information.

14. A program for causing a computer to perform information processing and execute:
a process of determining a request source of behavior history information which is behavior information in which a behavior pattern is analyzed from behavior information generated by a terminal apparatus, and a protection level of the behavior information is selected based on a similarity determination of the analyzed behavior pattern and a protection target behavior history pattern;
a process of selecting an access right corresponding to the determined request source; and
a process of providing the requested behavior history information when it is determined that the requested behavior history information has a protection level in which access is permitted by the access right corresponding to the request source based on the access right corresponding to the request source and the protection level of the requested behavior history information.

15. A server configuring a part of an information processing system, the server comprising:
a determining unit that determines a request source of behavior history information;
an access right database unit that selects an access right corresponding to the determined request source; and
an information provision processing unit that provides the requested behavior history information when it is determined that the requested behavior history information has a protection level in which access is permitted by the access right corresponding to the request source based on the access right corresponding to the request source and the protection level of the requested behavior history information,
wherein the information processing system further includes an information terminal, and at least one of the information terminal and the server further includes
a behavior pattern analyzing unit that analyzes a behavior pattern based on the behavior information supplied from the information terminal,
a similarity determining unit that performs a similarity determination of the analyzed behavior pattern and a protection target behavior history pattern,
a protection selecting unit that selects a protection level of the behavior information based on a result of the similarity determination, and
a behavior information protecting unit that protects the behavior history information which is behavior information in which a protection level is selected based on the selected protection level.

16. An information processing system, comprising:
an information terminal that generates behavior information; and
a server that provides behavior history information in response to a request,
wherein at least one of the information terminal and the server includes
a behavior pattern analyzing unit that analyzes a behavior pattern based on the behavior information,
a similarity determining unit that performs a similarity determination of the analyzed behavior pattern and a protection target behavior history pattern,
a protection selecting unit that selects a protection level of the behavior information based on a result of the similarity determination, and
a behavior information protecting unit that protects the behavior information based on the selected protection level, and
wherein the server includes
a behavior history information recording unit that records the behavior information as behavior history information,
a determining unit that determines a request source of the behavior history information,
an access right database unit that selects an access right corresponding to the determined request source, and
an information provision processing unit that provides the requested behavior history information when it is determined that the requested behavior history information has a protection level in which access is permitted by the access right corresponding to the request source based on the access right corresponding to the request source and the protection level of the requested behavior history information.

17. The information processing system according to claim 16,
wherein the information terminal is provided with a behavior pattern analyzing unit that analyzes a behavior pattern based on the behavior information, a similarity determining unit that performs a similarity determination of the analyzed behavior pattern and a protection target behavior history pattern, and a protection target behavior history pattern database unit that registers the protection target behavior history pattern, and
wherein the server is provided with a database integrating unit that acquires behavior history patterns from protection target behavior history pattern database units of information terminals, integrates the behavior history patterns, and registers an integrated database in the protection target behavior history pattern database units of the information terminals.

18. The information processing system according to claim 17,
wherein the database integrating unit anonymizes the behavior history patterns acquired from the protection target behavior history pattern database units of the information terminals.

19. An information processing method performed by an information processing system including an information terminal that generates behavior information and a server that provides behavior history information in response to a request, the method comprising:
by at least one of the information terminal and the server,
analyzing a behavior pattern based on the behavior information;
performing a similarity determination of the analyzed behavior pattern and a protection target behavior history pattern;
selecting a protection level of the behavior information based on a result of the similarity determination; and
protecting the behavior information based on the selected protection level; and
by the server,
recording the behavior information as behavior history information;
determining a request source of the behavior history information;
selecting an access right corresponding to the determined request source; and
providing the requested behavior history information when it is determined that the requested behavior history information has a protection level in which access is permitted by the access right corresponding to the request source based on the access right corresponding to the request source and the protection level of the requested behavior history information.
